(19) United States
(12) Patent Application Publication
(10) Pub. No.: US 2005/0252601 A1
(43) Pub. Date: Nov. 17, 2005

(54) Stretchable, intra-curing halogenated based rubber tape

(76) Inventor: Paul R. Rust, Evansville, IN (US)

Correspondence Address: Gary K. Price, Esq., Bowers Harrison, LLP, 25 N.W. Riverside Drive, Evansville, IN, 47706-1287, US

(21) Appl. No.: 11/128,567

(22) Filed: May 13, 2005

Related U.S. Application Data
(60) Provisional application No. 60/571,543, filed on May 13, 2004.

(51) Int. Cl. B32B 31/00

(52) U.S. Cl. 156/160; 156/333

(57) ABSTRACT

A stretchable, intra-curing halogenated based rubber composition having increased strength and capable of being stretched without breaking. The composition comprises blends of a first halogenated rubber component and a second halogenated modified rubber component. The present invention further relates to methods for preparing these compositions.

### CROSS REFERENCES TO RELATED APPLICATIONS

U.S. Provisional Application for Patent No. 60/571,543, filed May 13, 2005, with title “Stretchable, Intra-Curing Halogenated Based Rubber Tape” which is hereby incorporated by reference. Applicant claims priority pursuant to 35 U.S.C. Par. 119(e)(i).

Statement as to rights to inventions made under federally sponsored research and development: Not Applicable

### BACKGROUND OF THE INVENTION

1. Field of the Invention

The present invention relates generally to the field of tapes which are substantially non-tacky in their relaxed state but whose overlapping layers self- bond when stretched and wrapped on a substrate.

2. Brief Description of Prior Art

Many articles are coated for protection from the environment in a variety of ways including the application of a thin sheet or tape in a wrapping operation. The technology for the application of such coatings generally includes a separate adhesive layer used to achieve adhesion to the substrate and of the overlapping layers to each other. These tapes are usually made of a non-cured single layer of self-fusing elastomers. The fusing of the tape is due to each adjacent layer or double layer being composed of the same compound and therefore compatible and fusable. Upon exposure to temperature, these tapes lose their elastomeric memory and assumes the applications shape.

As will be seen from the subsequent description, the preferred embodiments of the present invention overcome shortcomings of the prior art.

### SUMMARY OF THE INVENTION

The present invention relates generally to a rubber composition and a method of forming a curing composition blend. By inciting cross-linking between layers, the one layer is substantially non-tacky in the relaxed state while the adjacent layer is tacky. Both layers are composed of a semi-cross-linked elastomer that when forced into intimate contact, will further fuse with increase of time and temperature providing improved stability and strength. This results in a continued presence of an inward pressure on the wrapped area for the life of the splice.

The rubber composition blend is comprised of multiple components. One component is a halogenated rubber, or combination thereof, and a second component is a non-halogenated rubber.

### BRIEF DESCRIPTION OF THE DRAWINGS

The present invention will be illustrated on the basis of the following description of the preferred embodiments thereof.

### DESCRIPTION OF THE PREFERRED EMBODIMENT

In accordance with the present invention, a stretchable, self-shrinking, intra-curing halogenated based rubber, and method of forming the composition blend is disclosed. The present invention discloses a rubber composition that is substantially non-tacky in the relaxed state but whose overlapping layers cross-link layer to layer when stretched and wrapped on a substrate. In the broadest context, the composition blend of the present invention consists of components configured and correlated with respect to each other so as to attain the desired objective.

The blend of the present invention comprises at least two components: a halogenated rubber component and a halogenated modified component.

Any cross-linkable polymer may be employed in the practice of this invention. The halogenated rubber component may include, but is not in any way limited to, the following polymers: butyl rubber, halogenated butyl rubber, isobutylene homopolymer, ethylene/propylene/diene terpolymers, ethylene/propylene copolymers, polybutadiene, polyisoprene, halogenated isoolefin/paralkylstyrene copolymer, natural rubber, and combination mixtures thereof.

The blended composition further includes a cure system to allow the resultant product to have cross-linkable properties at room temperature. The cure system as will be described is preferably blended with the halogenated rubber component.

The cure system is a combination of phenolic resins. The amount of the curing agent will generally vary depending upon the types utilized and especially the desired degree of cure, as is well recognized in the art. However, in general, the preferred amount of the cure system is about 0.5% to about 1.5% of the total mixture blend.

It has now been found that the incorporation in the halogenated rubber component of the described cure system, in the amounts described, produces a marked improvement in the resultant product's cross-linking properties and further causes the blend to be room temperature cross-linkable.

Various additives can be further used in suitable amounts. For example, various reinforcing agents or fillers known in the art may be combined with the blend at any point during production. Further, various colorants may be added such as carbon black and the like, and various resins known in the art can be utilized in the present blend. Moreover, the inclusion of a separate tackifier known in the art and known for its intended purpose is preferred.

The described mixture further incorporates a petroleum product, preferably polybutene. The preferred proportion of polybutene in the mixture is from about 20% to about 30% of the total mixture.

The first halogenated rubber component which includes the cure system, and the non-halogenated component are combined in amounts effective to produce the desired improvement in strength and stability. The relative amounts are as follows:

The relative proportions of the halogenated rubber component used in the practice of the present invention fall within a rather narrow range. The proportion of the halogenated rubber component is from about 10% to about 25% of the total blend. A wetting agent known in the art is further included with the halogenated rubber component. The wetting agent as is known, causes the mixture to blend easier. The preferred proportion of the wetting agent is from about 0.5% to about 1.5% of the total blend;

It is preferred to use from about 1% to about 1.5% of colorant in the total blend. To achieve the desired effect it is preferred to use carbon black in the composition;
as stated, the preferred proportion of petroleum product in the mixture is from about 20% to about 30% of the total mixture;
the amount of a particular, filler or pigment which can be used without adversely affecting the fusion properties for example of the resultant product can be readily determined by those skilled in the art. However, such filler can be included in an amount equal to about 48% to about 55% of the blend;
the amount of the tackifier in the mixture is from about 0.5% to about 1.5% of the total mixture;
provided that the proportion of the halogenated rubber component (including the wetting agent and the cure system) in the mixture does not exceed about 30% of the total blend; and the proportion of the cure system in the mixture does not exceed about 1.5% of the total mixture.

The present invention further includes a removable liner known in the art that is temporarily adhered to a surface of the resulting sheet or tape product.

The resulting sheet or tape product are strong but can readily be stretched without breaking and are readily handleable over a wide temperature range.

In practicing the present invention, there is formed a blend which is capable of cross-linking. The application forms a continuous, solid rubber cover that applies inward pressure on the protected area for the life of the application.

The method used to combine the components is not critical and known in the art. Thus any mixing device may be used. Further, the mixing order is not critical. For convenience, the components may be blended at one time. Alternatively, the first halogenated rubber component (and components of the described cured system) may be blended first, followed by addition of the non-halogenated components and additives. The composition blend may include for example, initially blending the ingredients in solid form using standard blending equipment at elevated temperatures to improve blending. The resultant blend is then usually cooled, and preformed. Sheets may be prepared such as by passing the blend through a calendar or an extruder equipped with a sheet die. Tapes are produced by cutting or extruding the sheet to form tapes having the desired width.

Both layers of the rubber composition are post cured after forming into the final product. The application forms a stretchable tape with “built-in” memory to reform back to its shape before stretching.

The tape is applied to the substrate by subjecting it to a stretching elongation and in the elongated state applying it to the substrate, as for example in a wrapping action. Such stretching results in the tapes developing the ability to self-bond and the overlapping layers adhere strongly to each other. These layers have the appearance of a fused sheet on, or covering the substrate within a few hours of application. We have found that the layers will cross-link and continue to fuse with the increase of time and temperature following application until the layers of tacky and non-tacky elastomer have formed cross-linked adhesive bonding between layers. The rebounding properties of the cured non-tacky layer will, during the life of the application, exert an inward pressure that will prevent intrusion of extrusion of water, gases, air, dirt, or other elements.

It has been found that the blended composition demonstrates substantially improved thermal and aging stabilization. Thus, not only is the strength improved, the overall characteristics of the resultant product are improved.

The resulting tapes of the present invention may be used in a wide variety of applications such as splicing, encapsulation and connection.

Although the description above contains many specificities, these should not be construed as limiting the scope of the invention but as merely providing illustrations of some of the presently preferred embodiments of the invention. It will be obvious that embodiments described may be varied in many ways. Such variations are not to be regarded as a departure from the spirit and scope of the invention, and all such modifications as would be obvious to one skilled in the art are intended to be included within the scope of the present invention.

Thus the scope of the invention should be determined by the appended claims and their legal equivalents, rather than by the examples given.

1. In the method of coating a substrate by wrapping it with a tape comprising a removable liner and an adhesive layer, said adhesive layer comprising a blend of a cross-linkable halogenated rubber component, a non-halogenated modified component, and a cure system, said cure system comprising a combination of phenolic resins of about 0.5% to about 1.5% of the total mixture blend.

2. The method as recited in claim 1, wherein said blend further comprising a petroleum product of about 20% to about 30% of the total mixture.

3. The method as recited in claim 2, wherein the petroleum product is polybutene.

4. The method as recited in claim 1, wherein the halogenated rubber component is of about 10% to about 25% of the total mixture blend.

5. The method as recited in claim 4, wherein the halogenated rubber component is further blend with a wetting agent of about 0.5% to about 1.5% of the total blend.

6. The method as recited in claim 1, further comprising a colorant of about 1% to about 1.5% of the total blend mixture.

7. The method as recited in claim 6, wherein the colorant is carbon black.

8. The method as recited in claim 1, further comprising a filler.

9. The method as recited in claim 8, wherein the filler is about 48% to about 55% of the total blend mixture.

10. The method as recited in claim 1, wherein the proportion of the halogenated rubber component does not exceed about 30% of the total blend mixture.

11. The method as recited in claim 1, wherein the proportion of the cure system does not exceed about 2% of the total blend mixture.

12. The method as recited in claim 1, further comprising a tackifier of about 2% of the total blend mixture.

13. The method as recited in claim 1, including the step of forming the resultant blend into a length of sheets.

14. The method as recited in claim 13, wherein the resulting sheet further includes said removable liner removably attached to a surface of the sheet.

15. The method as recited in claim 1, wherein the halogenated rubber component is selected from the group consisting of butyl rubber, halogenated butyl rubber, isobutylene homopolymer, ethylene/propylene, diene terpolymers, ethylene/propylene copolymers, polybutadiene, polyisoprene, halogenated isoolefin/paralkylstyrene copolymer, natural rubber, and combination mixtures thereof.

16. The process of affixing to a substrate a tape having insufficient tack to self-bond in their relaxed state and comprising a mixture of:
(a) from about 10% to about 25% of the total blend mixture of a cross-linkable halogenated rubber component,
(b) from about 0.5% to about 1.5% of the total blend mixture of a cure system comprising a combination of phenolic resins,
(c) from about 20% to about 30% of the total blend mixture of a petroleum product,
(d) from about 1% to about 1.5% of the total blend mixture of colorant,
(e) from about 48% to about 55% of the total blend mixture of a filler, wherein said tape is subjected to a stretching elongation immediately prior to contact with the substrate, and wherein the elongated tape is applied to the substrate in a wrapping operation whereby the overlapping layers of said tape self-bond to each other.

17. The process of claim 16, wherein the colorant is carbon black.

18. The process as recited in claim 16, wherein the petroleum product is polybutene.

19. The process as recited in claim 16, further comprising a tackifier of about 2% of the total blend mixture.

20. The process as recited in claim 16, wherein the tape further comprises a removable liner removably attached to a surface of the tape.
